(19) United States
(12) Patent Application Publication
(10) Pub. No.: US 2012/0228399 A1
(43) Pub. Date: Sep. 13, 2012

(54) ILLUMINATED SPRINKLER WITH MICRO-GENERATOR

(76) Inventor: Ron Forhan, Hill Air Force Base, UT (US)

(21) Appl. No.: 13/045,885

(22) Filed: Mar. 11, 2011

(51) Int. Cl. B05B 17/04; F21S 8/00

(52) U.S. Cl. 239/19

(57) ABSTRACT

The present invention relates generally to an illuminated lawn and garden sprinkler. More specifically, this disclosure relates to an, electrically independent, illuminated lawn and garden sprinkler, using a micro-generator for power and advanced circuitry, including a photoelectric sensor, for display control. Illuminated sprinklers are an aesthetic enhancement using light to interplay with the discharging water and highlighting landscaping. Illuminated sprinklers encourage nighttime watering, increasing watering efficiency and water conservation.

### BACKGROUND OF THE INVENTION

The present invention relates generally to an illuminated lawn and garden sprinkler. More specifically, this disclosure relates to an, electrically independent, illuminated lawn and garden sprinkler, using a micro-generator for power and advanced circuitry for display control.

Lawn and garden care and outdoor ornamentation are multi-billion dollar industries in the United States. Home owners watch each spring for the latest technology trend to beautify their yards and to keep a step ahead of the neighbor's creations. Improvements in watering, water conservation, power conservation and lighting are obvious areas for yard improvement.

One idea that has been brought forward before, but has failed to gain acceptance, is to combine a water sprinkler with ornamental lighting. An early attempt to combine the two features is U.S. Pat. No. 1,929,825 for an Illuminable Sprinkler, to Requa, filed Jan. 14, 1932. This device was limited by the technology of the day and would be cost prohibitive in today's market. The device is a moveable above ground sprinkler and due to the number of moving rotating parts, and would not be compatible in a buried application. Other more recent applications for illuminated sprinklers include, U.S. Pat. No. 5,823,431, for an Illuminated Lawn Sprinkler, to Pierce, filed Aug. 13, 1996 and U.S. Pat. No. 6,644,561, for Color Beam Sprinkler Lights, to Danne, filed Mar. 12, 2002. The Pierce device is a movable above ground device, while the Daane device is a pop-up sprinkler. Both of the aforementioned devices require batteries for electrical power. Battery operated devices require the user to periodically remove and replace the batteries. Presently available batteries are toxic and require special disposal and if exposed to water, batteries may leach toxic chemicals into the user's lawn or gardens.

What is needed is an illuminated sprinkler that is functional in a buried lawn and garden application, is self-powered to eliminate maintenance and does not use toxic batteries.

### SUMMARY OF THE INVENTION

A first embodiment of the present invention is an illuminated sprinkler having a micro generator. The device is self-powered, in that it generates electrical current using a micro-generator, to energize the lighting display. The illuminated sprinkler provides the advantage of creating an esthetically pleasing lighting display each time the lawn is watered. In one embodiment, the lighting display is controlled using a photoelectric switch to prevent the lights from coming on during day light hours. Shutting off power to the lighting display during daylight extends the life of the bulbs and helps incentivize the user to limit outdoor watering to nighttime hours. Nighttime watering reduces water loss due to vaporization, increases soil saturation, and is mandatory in some municipalities where conservation statutes are in place.

Another embodiment of the present invention, is an illuminated sprinkler with micro-generator; the sprinkler having a body portion, a line attachment and top cover. A micro-generator is incorporated into the body portion. The micro-generator consisting of, an impeller placed into the water inlet stream of the sprinkler and attached to a direct current (DC) motor for power generation. The top cover having a fixed spray nozzle and a plurality of light elements focused toward the spray discharge. When water is introduced into the sprinkler, the flow of water through the inlet turns the impeller and DC motor. The rotating motion of the motor armature and windings cutting through a magnetic field generates an electrical current, powering the light elements. When the water supply is shut off, the impeller will no longer turn and power to the light elements will discontinue. It is contemplated to use light emitting diodes or LEDs for the light elements.

In yet another embodiment of the present invention, the illuminated sprinkler includes, a photosensitive switch and control circuitry, limiting activation of the light elements to situations when the sprinklers are flowing during nighttime hours.

In one embodiment of the present invention the illuminated sprinkler is a pop-up version, allowing the sprinkler to be buried substantially at or below the ground level but when water pressure is applied the discharge nozzle extends out of the sprinkler body, allowing water to be discharged without interference by long grass or plants. The lighting element can be focused toward the water discharge creating a colored glow or halo effect.

In yet another embodiment of the present invention, the illuminated sprinkler is a pop-up version having a transparent light emitting discharge riser. At least some of the lighting elements disposed inside of the sprinkler body and focused or directed toward a perpendicular collection lens in the base of the discharge riser. The light collected through the lens is channeled though elevated riser creating a glowing effect. This allows the light source to be clearly viewed about the surface of the lawn or plants and creates an interesting inter-play between the light and water. Additional light elements on the sprinkler cap may also be included. In one embodiment, the discharge nozzle may be configured as a transparent ornamental shape attached to the discharge riser. Light traveling through the riser will be transferred into the discharge nozzle causing the ornamental shape to glow. The ornamental shape may include, but is not limited to, objects in nature, such as a, bee, butterfly, lady bug, frog, snail or fish or a geometric shape, such as a, star, square, triangle, diamond, sphere, hemisphere, or a prism. It is contemplated that the transparent material is clear in color or colored to improve attractiveness. Additionally, it is contemplated the lighting elements or LEDs for each embodiment are a single color, a color pattern, multi-colored or color changing.

In one embodiment the light elements for the illuminated sprinkler include light filaments that extend away from the sprinkler body.

In another embodiment, the illuminated sprinkler is a portable unit where in the micro-generator is proximate the hose inlet and the lighting elements are focused on the water discharge. The portable sprinkler may be configured with an oscillating spray hoop, non-moving spray disk or as an oscillating impact sprinkler. The light elements may be interspersed between the discharge openings on the oscillating hoop, on the top surface of the non-moving disk, or may be focused into the discharge stream of the impact sprinkler.

In yet another embodiment of the present invention, the illuminated sprinkler is a hose end hand held sprinkler or sprayer. It is contemplated that the micro-generator is installed into the water stream near the hose attachment and the light elements will focus on the water stream or the area to be watered. The light elements will be activated when the discharge valve or trigger mechanism of the hose end sprayer is opened.

In one embodiment of the illuminated sprinkler of the present invention, it is contemplated to replace the micro-generator with a compact solar electric collector attached to the top of the sprinkler housing. Energy could be stored in a battery or capacitor and activated by a water flow sensor, light sensor or a combination of both water flow and light sensors. This embodiment provides the advantage of allowing all electrical components to be isolated to the cap portion of a traditional sprinkler and eliminated the moving parts required for the micro-generator.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set forth hereinafter.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 illustrates an illuminated sprinkler in accordance with one embodiment of the disclosure;

FIG. 2 illustrates an illuminated sprinkler in accordance with one embodiment of the disclosure;

FIG. 3 illustrates one embodiment of the micro-generator of the present invention;

FIG. 4 illustrates one embodiment of the micro-generator of the present invention;

FIG. 5 illustrates a flow diagram of the electrical components of one embodiment of the present invention, and;

FIG. 6 illustrates an illuminated sprinkler in accordance with another embodiment of the disclosure.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with definitions set out below. As used herein, the terms “comprising,” “including,” “containing,” “characterized by,” and the grammatical equivalents thereof are inclusive or open-ended terms that do not exclude additional, unrecited elements or method processes.

The disclosure relates to an illuminated sprinkler, or more specifically, this disclosure relates to a self-powered, illuminated sprinkler having a micro-generator and advanced control circuitry.

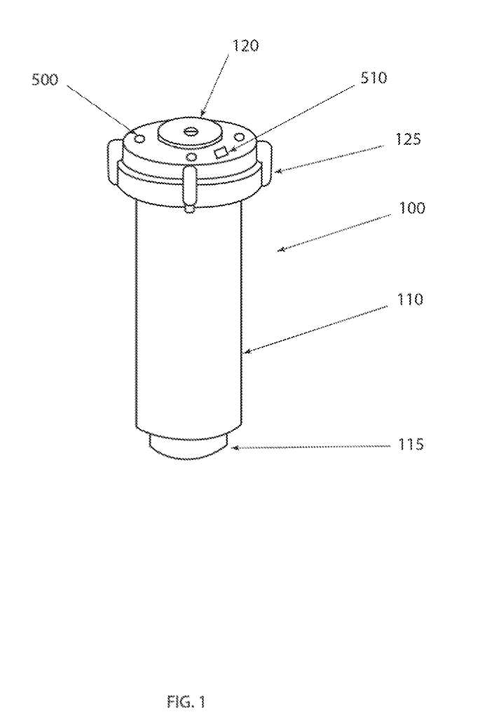

Illustrated in FIG. 1, is a first embodiment of the illuminated sprinkler 100 of the present invention. The illuminated sprinkler including body portion 110, having inlet end 115 and a cap 125. Integrated into cap 125 is spray nozzle 120, lighting elements 500 and photo electric sensor 510. In one embodiment, the lighting element activates as soon as water pressure is applied, in yet another embodiment, photoelectric sensor 510, and associated control circuitry (not shown), prevents the lighting elements 500 from energizing unless it is dark outside.

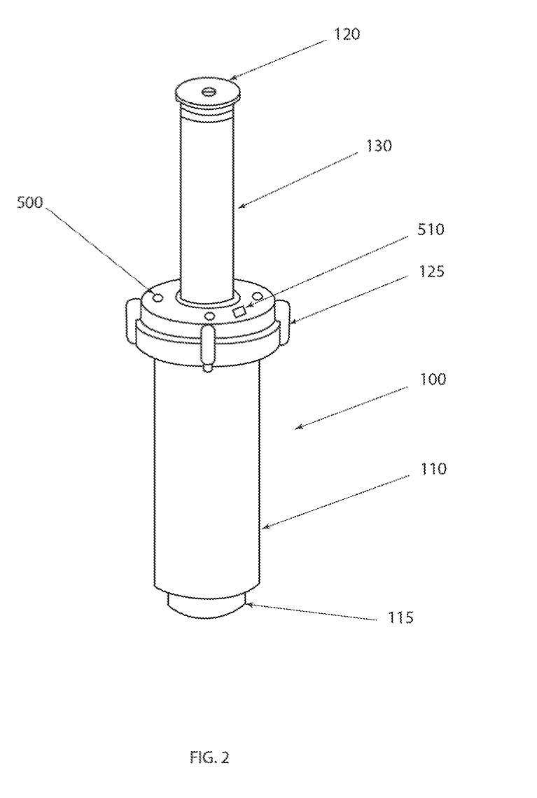

FIG. 2 illustrates another embodiment of the present invention where illuminated sprinkler 100 is a pop-up type device including a movable discharge riser 130. When water pressure is applied, the discharge riser 130 extends out of the sprinkler body 110. Discharge riser 130 elevates nozzle 120 above surrounding impediments, such as, long grass and shrubs, providing more even watering. The elevated discharge also improves visibility of the illuminated water stream when lighting elements 500 are activated.

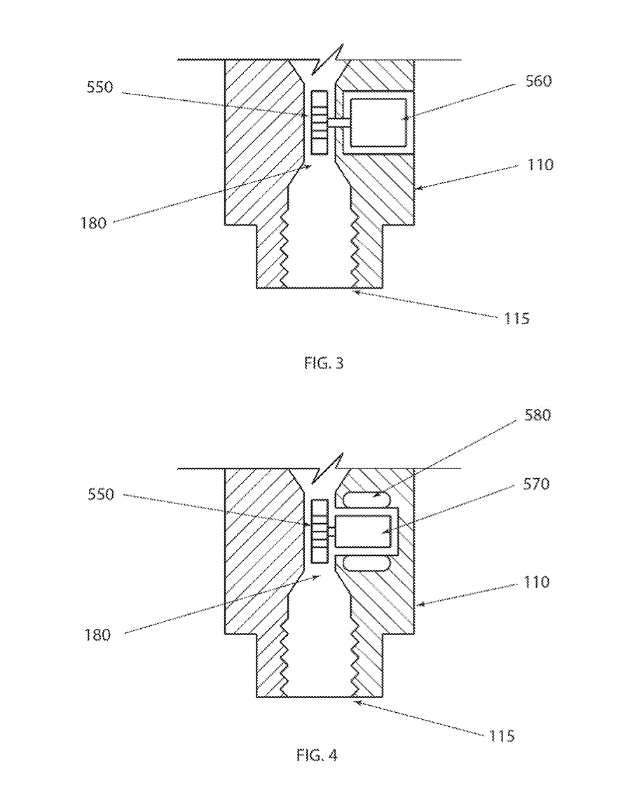

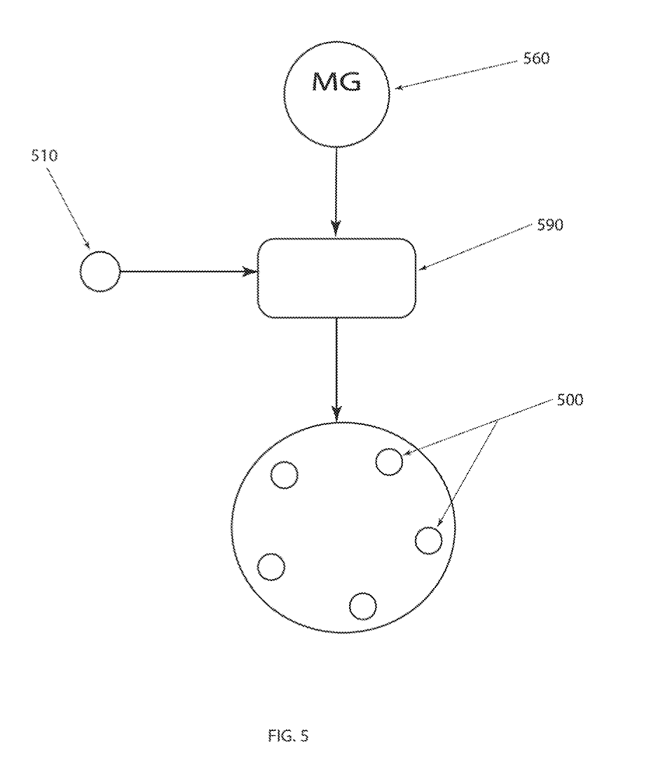

Illustrated in FIGS. 3 and 4 are embodiments of micro-generators 560 and 570. The embodiment of FIG. 3 is a micro-generator 560 installed in the base end of the sprinkler body 110, proximate the inlet 115. The micro-generator impeller 550 is introduced into the fluid stream in a flow restriction section 180. The impeller 550 is rotated by the moving fluid stream, which is accelerated by the flow restriction section 180. The rotation of impeller 550 correspondingly moves the armature windings of the micro-generator 560 through a magnetic field, creating electrical current used to power the lighting elements 500. The embodiment of FIG. 4 includes a micro-generator 570 where all electrical components are isolated from the water stream. Micro-generator 570 includes a magnetic drum that rotates within the electrical field of a set of fixed wire coils or windings 580, again, generating an electrical current.

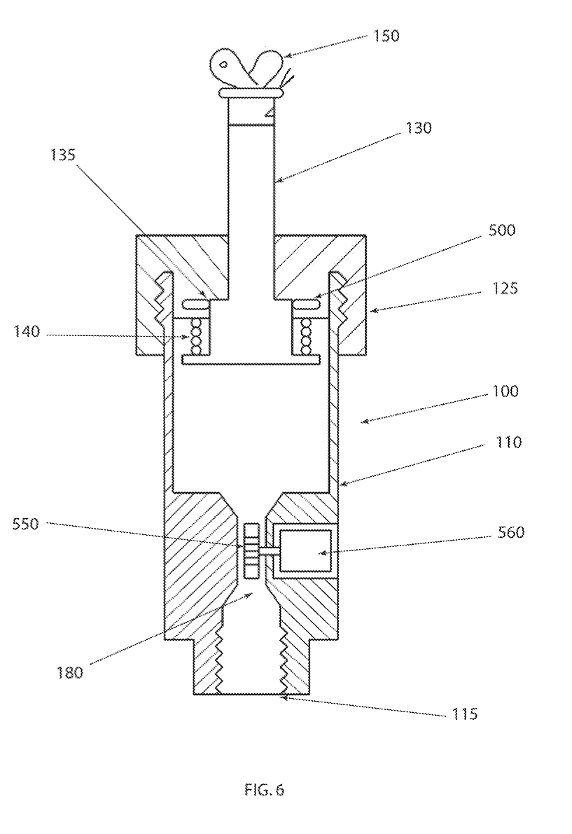

A basic electrical flow diagram is illustrated in FIG. 5. Power for illuminating lighting elements 500 is generated by micro-generator 560, the electrical current is routed through control circuitry 590. The control circuitry 590 does not allow electrical current to flow to lighting elements 500 when photoelectric sensor 510 detects light. This arrangement improves the service life of lighting elements 500 and encourages the user to water during nighttime hours.

FIG. 6 illustrates another embodiment of the illuminated sprinkler 100 of the present invention. The sprinkler 100 includes, sprinkler body 110 having inlet opening 115, a micro-generator 560 with impeller 550 introduced into the fluid stream in a flow restriction area 180. Sprinkler 100 is a pop-up design wherein, a nozzle riser 130 extends out of body 110 when water pressure is applied. Riser 130 is biased into a retracted position by return spring 140. The riser 130 and the ornamental spray nozzle 150 are constructed from a transparent, light transmitting material. When a current is generated and introduced into light elements 500, the light elements 500 will project into riser base lens surface 135 causing riser 130 and ornamental nozzle 150 to glow or transmit light.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A water sprinkler comprising:
a body portion, including, an inlet and a flow restriction;
a cap portion, including, a nozzle;
a micro-generator, including an impeller, and;
a plurality of light elements electrically connected to the micro-generator.

2. The water sprinkler of claim 1, wherein, the micro-generator impeller is installed in the flow restriction.

3. The water sprinkler of claim 1, including a photoelectric sensor electrically connected to a control circuit.

4. The water sprinkler of claim 1, wherein, when water is introduced into the inlet, the micro-generator impeller is rotated producing electrical current and causing the plurality of light elements to illuminate.

5. The water sprinkler of claim 3, wherein, the photoelectric sensor and control circuit, electrically connected intermediately with the micro-generator and the plurality of light elements; when water is introduced into the inlet, the micro-generator impeller is rotated producing electrical current, the plurality of light elements will illuminate if the photoelectric sensor doe not detect light.

6. The water sprinkler of claim 1, including a nozzle riser.

7. The water sprinkler of claim 1, including a nozzle riser having a light collection lens, the nozzle riser and nozzle composed of light collecting transparent material.

8. The water sprinkler of claim 7, wherein the nozzle is an ornamental shape.

9. The water sprinkler of claim 7, wherein at least one of the plurality of light elements directed into the light collection lens.

10. The water sprinkler of claim 1, wherein at least one the plurality of light elements disposed on the cap portion.

11. The water sprinkler of claim 1, wherein at least one the plurality of light elements disposed on the body portion.

12. The water sprinkler of claim 1, wherein at least one the plurality of light elements disposed on the cap portion and at least one of the plurality of light elements disposed on the body portion.

13. The water sprinkler of claim 1, wherein at least one of the plurality of light elements is a LED.

14. The water sprinkler of claim 1, wherein at least one of the plurality of light elements is a light filament.
